(19) United States
(12) Patent Application Publication
(10) Pub. No.: US 2012/0158201 A1
(43) Pub. Date: Jun. 21, 2012

(54) SYSTEM AND METHOD FOR PROVIDING SECURITY BASED ON POWER CONSUMPTION

(75) Inventor: David S. Leeds, Lake Worth, FL (US)

(73) Assignee: OPENPEAK INC., Boca Raton, FL (US)

(21) Appl. No.: 12/973,592

(22) Filed: Dec. 20, 2010

(51) Int. Cl. G06F 1/28

(52) U.S. Cl. 700/293

(57) ABSTRACT

In a load monitoring unit capable of monitoring power usage of an electrical device, a method of detecting a possible security breach is described herein. In one arrangement, the method can include the steps of setting a power threshold in the load monitoring unit in which the power threshold corresponds to the electrical device and monitoring power usage of the electrical device through the load monitoring unit. The method can also include the step of generating a security breach signal if the power usage of the electrical device reaches the power threshold.

### FIELD OF TECHNOLOGY

The subject matter herein is directed to providing security and more particularly, to providing security based on power consumption.

### BACKGROUND

Many home and commercial environments are equipped with various security systems or components to help thwart break-ins. Examples of such systems include sensors strategically positioned at doors and windows, motion detectors and broken glass detectors. In view of their ubiquity, perpetrators of such crimes are well aware of these devices and take steps to avoid triggering them. Moreover, each of these devices requires the property owner to activate and deactivate them upon departure from and arrival at the protected structure, which can be an annoyance for the property owner. Additionally, almost all these devices require entry of a special code or password to become activated, which can be easily forgotten. The costs associated with buying and implementing these systems is another disadvantage.

### SUMMARY

In a load monitoring unit capable of monitoring energy usage of an electrical device, a method of detecting a possible security breach is described herein. In one arrangement, the method can include the steps of setting a power threshold in the load monitoring unit in which the power threshold corresponds to the electrical device and monitoring power usage of the electrical device through the load monitoring unit. The method can also include the step of generating a security breach signal if the power usage of the electrical device reaches the power threshold.

The method can also include the steps of transmitting the security breach signal to a network component and transmitting the security breach signal from the network component to a communication device that is configured to inform an operator of the communication device of the security breach signal. In addition, as an example, the power threshold is the activation of the electrical device or an increased power usage of the electrical device in comparison to a historical average power usage.

In one arrangement, the electrical device includes a plug, and the load monitoring unit includes a receptacle for receiving the plug. The plug from the electrical device can be engaged with the receptacle of the load monitoring unit while the load monitoring unit monitors power usage of the electrical device. In another arrangement, the electrical device is permanently wired to the load monitoring unit while the load monitoring unit monitors power usage of the electrical device.

The method can also include the step of controlling an operation of the electrical device through the load monitoring unit. For example, controlling an operation of the electrical device at least includes automatic activation of the electrical device. Examples of the electrical device include an illumination device, an appliance, a computer, an entertainment device, a water heater, a heating system or an air conditioning system. Monitoring power usage of the electrical device can include, for example, monitoring power usage during a predetermined time period or in response to an activation of a security system. Also, the electrical device can be positioned in a protected area, and the method can further include the step of triggering an alarm to be detected in the protected area.

Another method of detecting a possible security breach is described herein. This method can include the steps of monitoring power usage of one or more electrical devices, comparing the monitored power usage of the electrical device with one or more corresponding power thresholds and generating a security breach signal in response to the monitored power usage of the electrical device meeting or exceeding the corresponding power threshold. The method can also include the step of transmitting the security breach signal to a communication device that is configured to inform an operator of the communication device of the security breach signal.

As an example, the power threshold can be the activation of the electrical device or an increased power usage of the electrical device in comparison to a historical average power usage. The method can also include the step of receiving power usage data from one or more load monitoring devices associated with the electrical devices.

A load monitoring unit is also described herein. The load monitoring unit can include an interface configured to couple an electrical system to one or more electrical devices that are configured to receive power from the electrical system and a power monitor configured to monitor power usage of the electrical device. The load monitoring unit can also include a processor in which the processor is operable to compare the monitored power usage of the electrical device to a power threshold and generate a security breach signal if the monitored power usage meets or exceeds the power threshold.

The load monitoring unit can also be equipped with a transceiver that transmits the security breach signal to a network component for eventual receipt at a communication device. The communication device can provide an indication of a potential security breach in response to the receipt of the security breach signal. In addition, the power threshold can be a state condition, like the activation of an electrical device, or a historical average power consumption. In one embodiment, the interface can include a plug and a receptacle in which the plug is configured to engage an electrical outlet, and the receptacle can be configured to engage one of the electrical devices. In another embodiment, the interface can be configured to be permanently wired to at least one of the electrical devices.

A monitoring unit is also described herein. The monitoring unit, which may be referred to as a central monitoring unit, can include an interface that is configured to receive power usage data associated with one or more electrical devices. This monitoring unit can also include a processor in which the processor can be configured to receive the power usage data, compare the power usage data with one or more power thresholds and generate a security breach signal if the power usage data meets or exceeds at least one of the power thresholds. The monitoring unit can also contain a transceiver that can be configured to transmit the security breach signal to a network component.

As an example, the interface is a wireless interface that can be configured to receive wireless signals from one or more load monitoring units that monitor the power usage of the electrical devices. Moreover, the load monitoring units can be configured to receive power from an electrical system and provide that power to the electrical devices. As another example, the power threshold is a state condition or a historical average power consumption.

### BRIEF DESCRIPTION OF THE DRAWINGS

Embodiments of the present application will now be described, by way of example only, with reference to the attached Figures, wherein:

FIG. 1 illustrates an example of a security system that at least monitors power usage of one or more electrical devices; and

FIG. 2 illustrates an example of a block diagram of a load monitoring unit and a central monitoring unit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

Several definitions that apply throughout this document will now be presented. A “load monitoring unit” is defined as a device that controls and/or monitors power being supplied to a load and is configured to communicate—wirelessly or wired—with one or more other components. A “monitoring unit” is defined as a device that at least monitors data associated with one or more electrical devices. The word “control” means to exercise direction or regulation over another component, while the word “monitor” means to observe, record or detect. A “security breach” is defined as unauthorized access or attempted access to an area, setting, environment or platform. The term “power threshold” is defined as a predetermined setting, measurement, value or condition associated with the amount of power consumed by an electrical device. The term “power usage” is defined as a process of consuming power to perform a certain function and includes instantaneous changes in power as well as the consumption of power over a period of time. A “security breach signal” is a signal that is generated in response to the detection of a security breach or a possible security breach. The term “network component” is defined as a device that is part of a network, which includes networks that are under the coordination of a central controller or networks that have no central controller.

The word “activation” is defined as a process of transitioning a component from one state to another in which the power usage of the component in the transitioned-to state is different from the power usage of the component in the transitioned-from state. The term “historical average power usage” is defined as the average power consumption by an electrical device over a predefined time period. The term “permanently wired” is defined as an electrical contact or connection that involves more than temporary coupling of electrical wires.

The term “interface” is defined as a component or a group of components that enables a device that includes the interface to communicate with or be coupled to one or more other devices for the purpose of transferring signals between the component(s) and the other device(s). A “power monitor” is a component or a group of components that is configured to monitor the power usage of one or more other electrical devices. A “processor” is a component or a group of components that is configured to execute any number of the processes described herein.

As noted earlier, conventional home security systems must be constantly activated and deactivated by property owners, and there is an expense associated with both their installation and monitoring. Moreover, thieves and intruders are typically aware of prior art security systems and techniques used to defeat them. To overcome these disadvantages, several examples of monitoring units and methods for operating them are presented here.

In one particular example, in a load monitoring unit capable of monitoring power usage of an electrical device, a method of detecting a possible security breach is described herein. In one arrangement, the method can include the steps of setting a power threshold in the load monitoring unit (or some other appropriate device) in which the power threshold corresponds to the electrical device and monitoring power usage of the electrical device through the load monitoring unit. The method can also include the step of generating a security breach signal if the power usage of the electrical device reaches the power threshold.

Such a process can enable a user to surreptitiously monitor his/her property in a way that cannot be easily defeated by an intruder. Moreover, the process can take advantage of a pre-existing smart meter network or other energy monitoring system to provide a security feature without the additional expense that is typically involved with conventional security systems. This security features can also be easily activated and can quickly provide notification to a property owner in the event of a possible security breach.

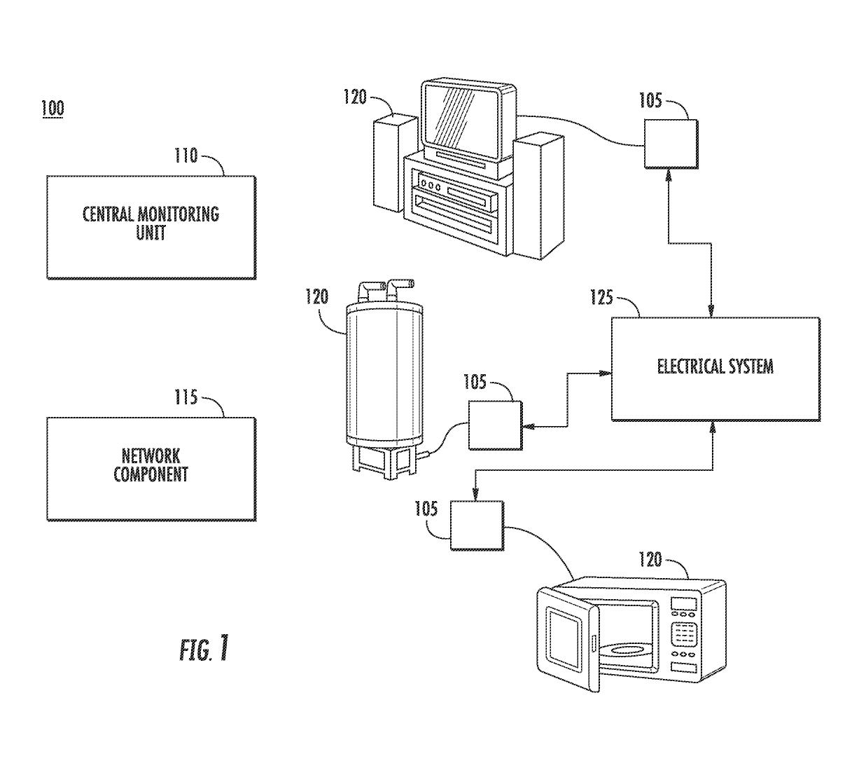

Referring to FIG. 1, a security system 100 is shown in which the system includes one or more load monitoring units 105 and a central monitoring unit 110. One or more network components 115 may be part of the system 100. The monitoring units 105 can be coupled to one or more electrical devices 120 and to an electrical system 125. The monitoring units 105 can be integrated into one or more of the electrical devices 120, or they can be considered separate items from the devices 120. In one arrangement, the monitoring units 105 can also be coupled to the central monitoring unit 110, and this coupling can be achieved through a hard-wired connection or a wireless connection. The monitoring units 105 can be directly coupled to the central monitoring unit 110, or they can be indirectly coupled to the central unit 110 through an intermediary device, like a router (not shown). In another arrangement, the monitoring units 105 can also be coupled to the network component 115 through a hard-wired or wireless connection.

In one embodiment, the monitoring units 105 can be configured to monitor the power usage of the electrical devices 120. For example, a monitoring unit 105 can be used to couple an electrical device 120 to the electrical system 125 and can determine a level or state of power usage of the device 120. The monitoring unit 105 can serve as a temporary coupling between the device 120 and the system 125, such as through a conventional plug and receptacle connection. Alternatively, the electrical device 120 can be permanently wired to the monitoring unit 105, and/or the unit 105 can also be permanently wired to the electrical system 125. Suitable (but non-limiting) examples of the electrical devices 120 include an illumination device, an appliance, a computer, an entertainment device, a water heater, a heating unit or system or an air conditioning unit or system. In addition, any suitable number of electrical devices 120 can be coupled to any suitable number of monitoring units 105. The load monitoring unit 105, in addition to monitoring power usage, can be used to control the operation of one or more of the electrical devices 120. This control can include automatic activation of the electrical devices 120, which can, for example, be programmed though the central monitoring unit 110.

In view of this arrangement, the load monitoring units 105 are positioned to monitor the power usage of the electrical devices 120. While this set up can be used, for example, to improve energy efficiency or to control the operation of electrical devices 120, it can also be used to detect a possible security breach. That is, if one or more of the monitoring units 105 detect power usage that is beyond a normal range, a security breach signal can be generated to inform a property owner or some other person or entity of a possible security breach.

As an example, the determination of a possible security breach can be determined at a particular load monitoring unit 105. In particular, the activation or increased usage of one or more electrical devices 120 may cause the monitoring unit 105 to generate a security breach signal, which it can then forward (directly or indirectly) to the central monitoring unit 110. In response, the central unit 110 can signal, for example, the network component 115, which can relay a relevant message to one or more communication devices. Alternatively, the load monitoring unit 105 can be configured to simply forward the breach signal to the network component 115 (directly or indirectly), thereby obviating the need for a central monitoring unit 110. In another example, the monitoring unit 105 can simply forward (directly or indirectly) monitoring data to the central unit 110, and the central unit 110 can detect the possible security breach and generate the security breach signal.

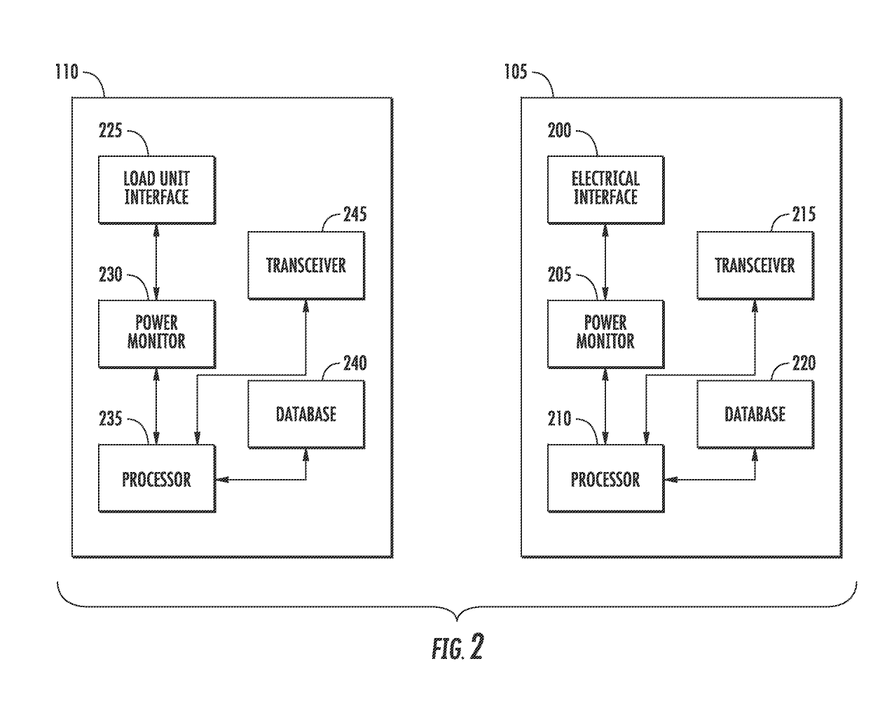

Referring to FIG. 2, example block diagrams of a load monitoring unit 105 and a central monitoring unit 110 are illustrated. In one arrangement, the monitoring unit 105 can include an electrical interface 200, a power monitor 205, a processor 210, a transceiver 215 and a database 220. It is understood that this configuration is merely exemplary in nature, as it is not necessary for the unit 105 to include each of the components shown here. Moreover, the monitoring unit 105 can include other components that are not shown here, as one skilled in the art would understand. Similarly, the central monitoring unit 110 can include one or more of the following components: a load unit interface 225, a power monitor 230, a processor 235, a database 240 and a transceiver 245. Also like the load monitoring unit 105, the central monitoring unit 110 is not required to contain each of these components and may contain other elements not listed here.

The electrical interface 200 of the unit 105 can be used to couple the load monitoring unit 105 to the electrical system 125. For example, the electrical interface 200 may include a receptacle (not shown) for receiving a plug (not shown) from an electrical device 120 and may also include a plug (not shown) for engaging an outlet (not shown) of the electrical system 125. As another example, the electrical interface 200 may be one or more permanent wiring connections for electrically coupling the load monitoring unit 105 to the electrical device 120 or the electrical system 125. Of course, the electrical interface 200 may employ other arrangements or structures for the purpose of coupling the unit 105 to the electrical device or electrical system 125.

The power monitor 205 can be configured to monitor the power usage of the electrical device(s) 120 to which the load monitoring unit 105 is coupled. The power monitor 205 can detect, for example, changes in the state of an electrical device 120, such as the electrical device 120 being turned on, or changes in the amount of power being used by an electrical device 120 over a period of time. This measure of the amount of consumed power can be either a decrease or an increase in overall power usage.

The processor 210 can be connected to each of other components of the load monitoring unit 105 and can signal these components to cause them to operate in accordance with the operations that are presented herein. Additionally, the transceiver 215 can be configured to at least transmit signals to any other suitable device, such as the central monitoring unit 110 or the network component 115. As an example, the transceiver 215 can operate in accordance with short range wireless protocols, like Bluetooth, Wi-Fi, ZigBee, etc. or wide range wireless protocols, such as any cellular based standards.

The database 220 can be a collection of data that is related to the power usage of one or more electrical devices 120. For example, the database 220 can include information that reflects the typical power usage of an electrical device 120, such as the normal amount of power used at a particular time of day, including whether a particular device 120 is usually on or off at a certain time. This database 220, and the determinations that can be made based on the information that it contains, may be useful in the event the load monitoring device 105 is configured to generate a security breach signal without the assistance of some other component. Although shown as separate components, any combination of the electrical interface 200, the power monitor 205, the processor 210, the transceiver 215 and the database 220 of the load monitoring unit 105 may be integrated with one another. For example, the power monitor 205 and the database 220 may be integrated into the processor 210.

Turning to the central monitoring unit 110, the load unit interface 225 can be configured to receive signals (hard-wired or wireless) from the load monitoring unit(s) 105, another device to which the load monitoring unit 105 is communicatively coupled or any other suitable device. In addition, the power monitor 230 can be configured to process information about the power usage of one or more of the electrical devices 120 and can forward this information to the processor 235. The processor 235, like the processor 210, can be coupled to and control the operation of any number of the components of the central monitoring unit 110. The database 240, similar to the database 220 of the load monitoring unit 105, can include information that is relevant to the power usage of one or more of the electrical devices 120. Finally, the transceiver 245 can signal other suitable devices, such as the network component 115. The transceiver 245 can be configured to at least transmit signals to the other devices, including the network component 115, through any suitable short-range or long-range format. In addition, the transceiver 245 is not limited to wireless transmissions, as the central monitoring unit 110 can be hard-wired connected to any other suitable device, including the network component 115.

Several examples of operation of the system 100 and its components will now be presented. In the first example, the central monitoring unit 110 can be responsible for generating the security breach signal if the detected conditions warrant such an event. In particular, the power monitor 205 of the load monitoring unit 105 can monitor the power usage of one or more electrical devices 120. If, for example, the electrical device 120 is activated or its power use is increased, the power monitor 205 can detect this change and can signal the processor 210 with this information. The processor 210 can then signal the transceiver 215, which can forward the detected power usage information to the central monitoring unit 110 or some other intermediary device, which can then send the information to the unit 110.

The load unit interface 225 can receive this signal, and the power monitor 230 can process it and forward relevant data to the processor 235. The processor 235 can then compare the measured power usage associated with the electrical device 120 with the data in the database 240, which can provide an indication as to whether the power usage is normal based on whether the power usage reaches or exceeds a power threshold. For example, if the electrical device 120 is an entertainment device and the energy monitor 205 of the load monitoring unit 105 determines that the entertainment device has been activated, the processor 235 of the central monitoring unit 110, once it received an indication of the activation, can access the database 240 to determine if the entertainment device is normally active at that particular time of activation. If the entertainment device is not normally active at that time (i.e., the power usage reaches the power threshold), the processor 235 can generate a security breach signal and can direct the transceiver 245 to forward the generated signal to, for example, the network component 115.

In one arrangement, the network component 115 is device that can relay communication signals to a communication network or a communication device. For example, the network component 115 can be a router that can forward the security breach signal to one or more communication units over the Internet, a cellular network, some other network. As such, the owner of the property in which the system 100 resides (or at least partially resides) can be apprised of the security breach signal. In another arrangement, the electrical device(s) 120 may be positioned in a protected area, and in addition to or in lieu of the generation of the security breach signal, an alarm can be triggered that can be detected in the protected area. For example, the alarm can be visual, audible or tactile in nature (or any combination thereof) such that it can be detected in the protected area by a human or appropriately configured machine.

In this embodiment, the database 240 of the central monitoring unit 110 can contain information about the power usage of one or more of the electrical devices 120. As an example, the database 240 can be programmed with one or more power thresholds that can trigger a security breach signal if they are met or exceeded. For example, schedules that show periods of time in which activation of the electrical devices 120 is normal or abnormal can be programmed into the database 240. As a more specific example, the owner of the property may program the database 240 to indicate that operation of an entertainment device between 9 a.m. and 5 p.m. on a non-holiday weekday is abnormal. Thus, if the processor 235 determines that the entertainment device is activated during this abnormal time, the processor 235 can generate the security breach signal. Similarly, the owner of the property may program the database 240 to indicate that a certain percentage change in a typical power usage pattern over the course of a time period during a particular part of the day warrants the generation of a security breach signal. The typical power usage pattern can be a historical average power usage for the relevant electronic devices 120. Thus, during a certain time of day, if an intruder activates the entertainment device and/or increases the output volume of the device beyond a level that may cause the power usage to exceed a predetermined threshold, then the central monitoring unit 110 may generate a security breach signal.

Of course, the description here is not meant to be limiting, as there are other measurements or criteria associated with power usage that can be used to determine that an intruder has entered an unauthorized area. For example, a decrease in the amount of power used by an electronic device 120 may also trigger a breach signal. In addition, the monitoring of the power usage of the electrical devices 120 can be performed on a continuous or periodic basis or in response to some predetermined event. In the case of a periodic basis, the monitoring can be performed on a cyclical basis in accordance with any suitable ratio (e.g., half-on, half-off) and can be limited to certain times of the day. An example of a predetermined event that may trigger the monitoring of power usage can be the activation of a security system, either locally or remotely.

Although the description above describes the central monitoring unit 110 as the component responsible for generating the security breach signal, it is not so limited. In particular, one or more of the load monitoring units 105 can be configured to generate the security breach signal and to forward the signal to, for example, the network component 115 or some other suitable element.

In this case, the power monitor 205 can monitor the power usage of the electrical device(s) 120 and can signal the processor 210 with data relating to such a process. In response, the processor 210 can compare the measured power usage with the information in the database 220. The database 220 can contain information like that explained above in relation to the database 240. Also similar to the embodiment previously described, the processor 210 can determine whether the comparison warrants the generation of a security breach signal. If it does, the processor 210 can direct the transceiver 215 to forward the security breach signal to the appropriate component(s). In one embodiment, the signal can be sent to the network component 115, which can take steps to inform a relevant user (or other machine). This monitoring can also be performed on a continuous or periodic basis or in response to a predetermined event.

Examples have been described above regarding a system and method for monitoring power usage and detecting a possible security breach in view of the monitoring. Various modifications to and departures from the disclosed embodiments will occur to those having skill in the art. The subject matter that is intended to be within the spirit of this disclosure is set forth in the following claims.

What is claimed is:

1. In a load monitoring unit capable of monitoring power usage of an electrical device, a method of detecting a possible security breach, comprising:
setting a power threshold in the load monitoring unit, wherein the power threshold corresponds to the electrical device;
monitoring power usage of the electrical device through the load monitoring unit; and
if the power usage of the electrical device reaches the power threshold, generating a security breach signal.

2. The method according to claim 1, further comprising transmitting the security breach signal to a network component.

3. The method according to claim 2, further comprising transmitting the security breach signal from the network component to a communication device that is configured to inform an operator of the communication device of the security breach signal.

4. The method according to claim 1, wherein the power threshold is activation of the electrical device or an increased power usage of the electrical device in comparison to a historical average power usage.

5. The method according to claim 1, wherein the electrical device includes a plug and the load monitoring unit includes a receptacle for receiving the plug and wherein the plug from the electrical device is engaged with the receptacle of the load monitoring unit while the load monitoring unit monitors power usage of the electrical device.

6. The method according to claim 1, wherein the electrical device is permanently wired to the load monitoring unit while the load monitoring unit monitors power usage of the electrical device.

7. The method according to claim 1, further comprising controlling an operation of the electrical device through the load monitoring unit, wherein controlling an operation of the electrical device at least includes automatic activation of the electrical device.

8. The method according to claim 1, wherein the electrical device is an illumination device, an appliance, a computer, an entertainment device, a water heater, a heating system or an air conditioning system.

9. The method according to claim 1, wherein monitoring power usage of the electrical device further comprises monitoring power usage during a predetermined time period or in response to an activation of a security system.

10. The method according to claim 1, wherein the electrical device is positioned in a protected area and further comprising triggering an alarm to be detected in the protected area.

11. A method of detecting a possible security breach, comprising:
monitoring power usage of one or more electrical devices;
comparing the monitored power usage of the electrical device with one or more corresponding power thresholds; and
generating a security breach signal in response to the monitored power usage of the electrical device meeting or exceeding the corresponding power threshold.

12. The method according to claim 11, further comprising transmitting the security breach signal to a communication device that is configured to inform an operator of the communication device of the security breach signal.

13. The method according to claim 11, wherein the power threshold is activation of the electrical device or an increased power usage of the electrical device in comparison to a historical average power usage.

14. The method according to claim 11, further comprising receiving power usage data from one or more load monitoring devices associated with the electrical devices.

15. A load monitoring unit, comprising:
an interface configured to couple an electrical system to one or more electrical devices that are configured to receive power from the electrical system;
an energy monitor configured to monitor power usage of the electrical device; and
a processor, wherein the processor is operable to:
compare the monitored power usage of the electrical device to a power threshold; and
generate a security breach signal if the monitored power usage meets or exceeds the power threshold.

16. The load monitoring unit according to claim 15, further comprising a transceiver that transmits the security breach signal to a network component for eventual receipt at a communication device, wherein the communication device provides an indication of a potential security breach in response to the receipt of the security breach signal.

17. The load monitoring unit according to claim 15, wherein the power threshold is a state condition or a historical average power consumption.

18. The load monitoring unit according to claim 15, wherein the interface comprises a plug and a receptacle, wherein the plug is configured to engage an electrical outlet and the receptacle is configured to engage one of the electrical devices.

19. The load monitoring unit according to claim 15, wherein the interface is configured to be permanently wired to at least one of the electrical devices.

20. A monitoring unit, comprising:
an interface that is configured to receive power usage data associated with one or more electrical devices;
a processor, wherein the processor is configured to receive the power usage data, compare the power usage data with one or more power thresholds and generate a security breach signal if the power usage data meets or exceeds at least one of the power thresholds; and
a transceiver that is configured to transmit the security breach signal to a network component.

21. The monitoring unit according to claim 20, wherein the interface is a wireless interface that is configured to receive wireless signals from one or more load monitoring units that monitor the power usage of the electrical devices.

22. The monitoring unit according to claim 21, wherein the load monitoring units are configured to receive power from an electrical system and provide that power to the electrical devices.

23. The monitoring unit according to claim 20, wherein the power threshold is a state condition or a historical average power consumption.
